(19) United States
(12) Patent Application Publication
(10) Pub. No.: US 2014/0139078 A1
(43) Pub. Date: May 22, 2014

(54) BRUSHLESS MOTOR

(71) Applicant: AISIN SEIKI KABUSHIKI KAISHA, Kariya-shi (JP)

(72) Inventor: Nobuyasu MIWA, Ichinomiya-shi (JP)

(73) Assignee: AISIN SEIKI KABUSHIKI KAISHA, Kariya-shi (JP)

(21) Appl. No.: 14/070,631

(22) Filed: Nov. 4, 2013

(30) Foreign Application Priority Data
Nov. 16, 2012 (JP) 2012-252638

(51) Int. Cl. H02K 11/00

(52) U.S. Cl. CPC H02K 11/0021
USPC 310/68 B

(57) ABSTRACT

A brushless motor includes a magnet rotor including a rotational shaft and a permanent magnet, the magnet rotor rotatable about the rotational shaft, a stator including plural teeth provided at a radial position being opposed to a circumferential surface of the magnet rotor, and a magnetic sensor for detecting a rotation position of the magnet rotor on the basis of a leakage magnetic flux of the magnet rotor leaking in an axial direction of the rotational shaft. The permanent magnet includes a short-sized portion provided at an axial end portion thereof facing the magnetic sensor, the short-sized portion having a shorter length than an entire radial dimension of the permanent magnet.

### CROSS REFERENCE TO RELATED APPLICATIONS

This application is based on and claims priority under 35 U.S.C. §119 to Japanese Patent Application 2012-252638, filed on Nov. 16, 2012, the entire content of which is incorporated herein by reference.

### TECHNICAL FIELD

This disclosure generally relates to a brushless motor.

### BACKGROUND DISCUSSION

A known brushless motor provided with a magnet rotor includes a magnetic sensor for detecting a rotation position of the magnet rotor on the basis of a leakage magnetic flux of the magnet rotor which leaks in an axial direction of the brushless motor.

According to the known construction for detecting the rotation position of the magnet rotor using the leakage magnetic flux, because the magnetic flux leakage is not stable, as illustrated in FIG. 10, changes in, or variations of the magnetic flux (magnetic flux density) that passes the magnetic sensor is apt to deviate from the ideal sinusoidal variation that accords to the rotation position of the magnet rotor. A known brushless motor illustrated in FIGS. 10 and 11 includes three Hall ICs serving as magnetic sensors and eight magnetic poles are formed on a magnet rotor of the brushless motor. As illustrated in FIG. 11, there is a problem that a rotation position of the magnet rotor cannot be detected with high precision because a phase (30°) set at each of the magnetic sensors and a polarity reversal cycle (45°) in accordance with the rotation of the magnet rotor are not properly reflected on an output signal (sensor signals S1 to S3) of each of the magnetic sensors.

For example, JP2005-57855A (i.e., hereinafter referred to as Patent reference 1) discloses a construction that a space portion with high reluctance is formed on a magnetic path by providing a rotor core with a hole portion axially penetrating the rotor core at a brushless motor having an embedded magnet type magnet rotor (i.e., interior permanent magnet motor, or IPM motor). Thus, by an increase of the leakage magnetic flux, or magnetic flux leakage in the axial direction, the rotation position of the magnet rotor is detectable with high precision.

However, according to the known construction disclosed in Patent reference 1, there is a drawback that an effective flux quantum contributing to the rotation of the magnet rotor is reduced by forming the region having high reluctance on the magnetic path.

A need thus exists for a brushless motor which is not susceptible to the drawback mentioned above.

### SUMMARY

In light of the foregoing, the disclosure provides a brushless motor, which includes a magnet rotor including a rotational shaft and a permanent magnet, the magnet rotor rotatable about the rotational shaft, a stator including a plurality of teeth provided at a radial position being opposed to a circumferential surface of the magnet rotor, and a magnetic sensor for detecting a rotation position of the magnet rotor on the basis of a leakage magnetic flux of the magnet rotor leaking in an axial direction of the rotational shaft. The permanent magnet includes a short-sized portion provided at an axial end portion thereof facing the magnetic sensor, the short-sized portion having a shorter length than an entire radial dimension of the permanent magnet.

According to another aspect of the disclosure, a brushless motor includes a magnet rotor including a rotational shaft and a permanent magnet, the magnet rotor rotatable about the rotational shaft, a stator including a plurality of teeth positioned at a radial position being opposed to a circumferential surface of the magnet rotor, and a magnetic sensor positioned being opposed to the permanent magnet, the magnetic sensor for detecting a rotation position of the magnet rotor on the basis of a leakage magnetic flux of the magnet rotor leaking in an axial direction of the rotational shaft. The permanent magnet includes a short-sized portion provided at an axial end portion thereof being opposed to the magnetic sensor, the short-sized portion having a shorter length than an entire radial dimension of the permanent magnet.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plane view of a brushless motor according to an embodiment disclosed here;

FIG. 2 is a cross-sectional view of the brushless motor according to the embodiment disclosed here;

FIG. 3 is a perspective view showing a short-sized portion provided at an axial end portion of a ring magnet facing a magnetic sensor according to the embodiment disclosed here;

FIG. 4 is a cross-sectional view showing the short-sized portion provided at the axial end portion of the ring magnet facing the magnetic sensor according to the embodiment disclosed here;

FIG. 5 is a waveform diagram showing changes in, or variations of leakage magnetic flux (flux density) that passes each of the magnetic sensors in accordance with a rotation position of a magnet rotor according to the embodiment disclosed here;

FIG. 6 is a waveform diagram showing changes in, or variations of an output signal waveform of each of the magnetic sensors in accordance with the rotation position of the magnet rotor according to the embodiment disclosed here;

FIG. 7 is a cross-sectional view showing a short-sized portion of a first modified example provided at the axial end portion of the ring magnet facing the magnetic sensor according to the embodiment disclosed here;

FIG. 8 is a cross-sectional view showing a short-sized portion of a second modified example provided at the axial end portion of the ring magnet facing the magnetic sensor according to the embodiment disclosed here;

FIG. 9 is a cross-sectional view showing a short-sized portion of a third modified example provided at the axial end portion of the ring magnet facing the magnetic sensor according to the embodiment disclosed here;

FIG. 10 is a waveform diagram showing changes in, or variations of leakage magnetic flux (flux density) which passes each of magnetic sensors in accordance with a rotation position of a magnet rotor according to a known device; and

FIG. 11 is a waveform diagram showing changes in, or variations of an output signal waveform of each of the magnetic sensors in accordance with the rotation position of the magnet rotor according to the known device.

### DETAILED DESCRIPTION

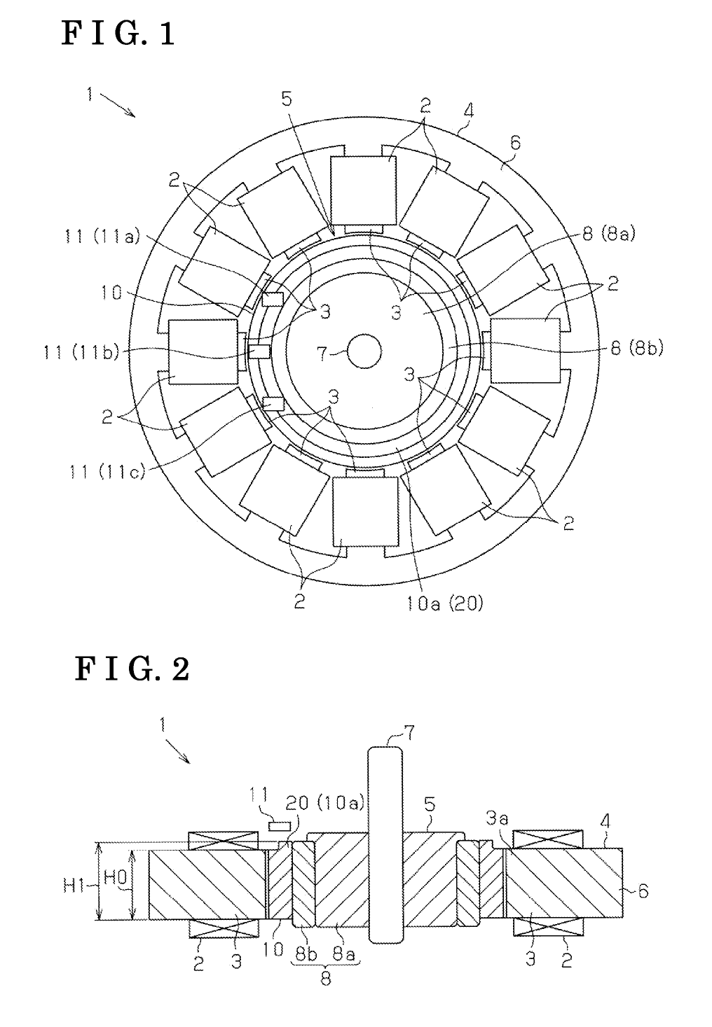

One embodiment will be explained with reference to illustrations of drawing figures as follows. As illustrated in FIGS. 1 and 2, a brushless motor 1 of the embodiment includes a stator 4 having plural teeth 3 on each of which a motor coil 2 is wound, and a magnet rotor 5 rotatably supported at a radially inward of the stator 4.

More specifically, the stator 4 of the embodiment includes, for example, twelve teeth 3 which protrude radially inward from an inner circumference of a base portion 6 formed in a substantially ring shape. The magnet rotor 5 includes a rotor core 8 fixed to a rotational shaft 7. The rotor core 8 includes an inner ward portion 8a fixed to the rotational shaft 7 and an outer ward portion 8b fixed to an outer periphery of the inner ward portion 8a. A ring magnet 10 serving as a permanent magnet is secured to an outer circumferential surface of the rotor core 8 (i.e., the outer ward portion 8b of the rotor core 8).

That is, the brushless motor 1 of the embodiment is formed as a surface permanent magnet motor (SPM motor) which includes a surface magnet type magnet rotor 5. The ring magnet 10 is magnetized to have, for example, eight magnetic poles. The teeth 3 of the stator 4 are positioned to be equally spaced around a circumference of the ring magnet 10 at radially outward positions where ends of the teeth 3 of the stator 4 face, or are opposed to an outer circumferential surface of the ring magnet 10.

The brushless motor 1 includes plural magnetic sensors 11 (11a, 11b, 11c) provided at positions facing, or being opposed to the ring magnet 10 of the magnet rotor 5 in an axial direction (i.e., a direction along an axis of the rotational shaft 7, an upper-middle portion in FIG. 2).

Particularly, according to the embodiment, a Hall IC for detecting leakage magnetic flux, or magnetic flux leakage of the magnet rotor 5 by a Hall element 12 provided therewithin is applied as each of the magnetic sensors 11 (11a, 11b, 11c). The magnetic sensors 11 (11a, 11b, 11c) are equally spaced (by 30° with mechanical angle, or mechanical degree) in a circumferential direction of the magnet rotor 5.

That is, the magnetic sensors 11 (11a, 11b, 11c) output sensor signals S1, S2, S3 in which levels of outputs changes in accordance with a rotation position of the magnet rotor 5, respectively, on the basis of the leakage magnetic flux of the magnet rotor 5 which passes the magnetic sensors 11 (11a, 11b, 11c). According to the embodiment, the rotation position of the magnet rotor 5 is detectable on the basis of a polarity reversal cycle at the sensor signals S1, S2, S3 and a phase of each of the sensor signals S1, S2, S3.

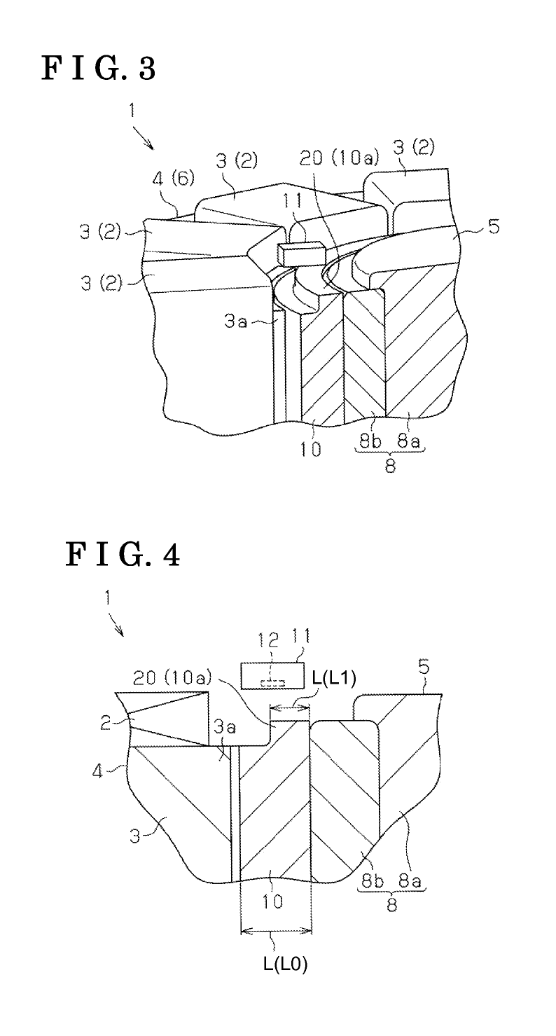

A structure for increasing leakage magnetic flux (leakage magnetic flux increasing structure) set at the magnet rotor 5 will be explained as follows. As illustrated in FIGS. 3 and 4, according to the embodiment, a thinner portion is formed on the ring magnet 10 provided at an outer circumferential surface of the magnet rotor 5 at an axial end portion 10a facing each of the magnetic sensors 11, that is, a short-sized portion 20 having a shorter length L1 in a radial direction (i.e., the length in right-left direction in FIG. 4) is formed.

Particularly, the short-sized portion 20 is formed by removing, or cutting out a portion of the axial end portion 10a at a radially outward side (outside) of the ring magnet 10 formed in a substantially cylindrical shape, thus to have a groove shape. Thus, the short-sized portion 20 is formed so that a radial dimension (radial length) L1 of the short-sized portion 20 is shorter than a radial dimension (radial length) L0 of other portions of the ring magnet 10.

Further, as illustrated in FIG. 2, the ring magnet 10 includes an axial dimension (axial height) H1 longer than an axial dimension (axial height) H0 of each of the teeth 3 provided facing, or being opposed to the ring magnet 10 in a radial direction. Further, as illustrated in FIGS. 3 and 4, the short-sized portion 20 is arranged at a position closer to the magnetic sensors 11 than the axial end portion 3a of each of the teeth 3 in an axial direction (i.e., upper position in FIG. 4).

Further, according to the embodiment, the Hall element 12 serving as a magnetic detection element is provided within each of the magnetic sensors 11 at a position facing, or being opposed to the ring magnet 10 in the axial direction (i.e., upward and downward direction in FIG. 4). Thus, according to the foregoing construction, the influence of the leakage magnetic flux to the stator 4 can be reduced.

Operations of the brushless motor 1 will be explained as follows. Because of the short-sized portion 20 formed at the axial end portion 10a of the ring magnet 10 to have radial dimension L1, an air gap between the short-sized portion 20 of the ring magnet 10 and each of the teeth 3 (an air gap relative to each of the teeth 3) positioned radially outward of the ring magnet 10 is enlarged at the axial end portion 10a. Accordingly, a region with high reluctance (high reluctance region) is formed, and thus the leakage magnetic flux, or magnetic flux leakage leaking in the axial direction of the magnet rotor 5 increases.

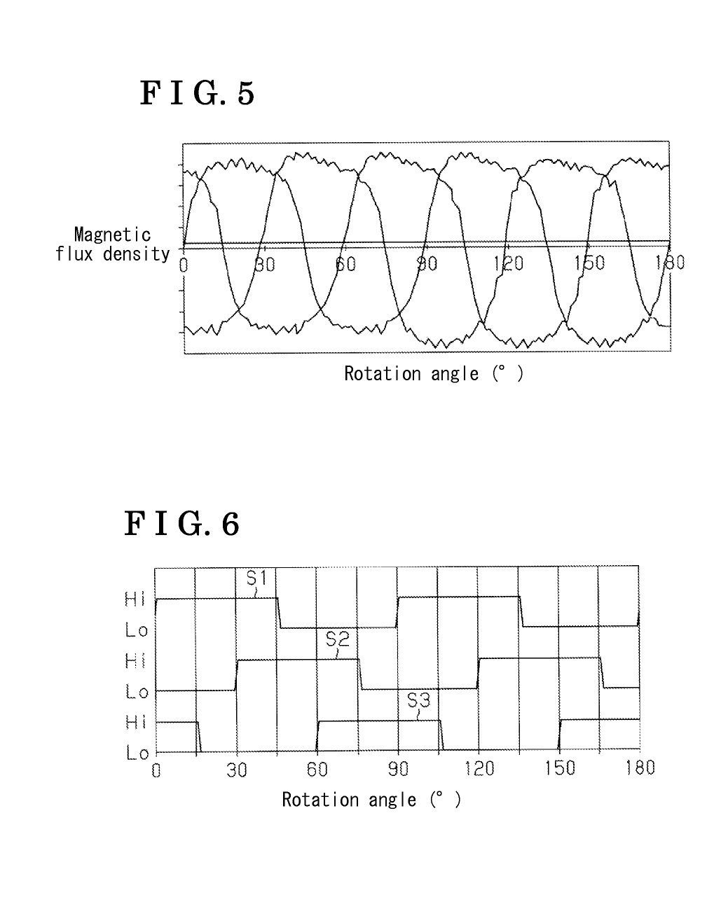

That is, as illustrated in FIG. 5, by an increase in the leakage magnetic flux in the axial direction of the magnet rotor 5, changes, or variations of the magnetic flux (flux density) that passes each of the magnetic sensors 11 come to be close to ideal sinusoidal variations in accordance with the rotation position of the magnet rotor 5. As illustrated in FIG. 6, the phase (e.g., 30°) set at each of the magnetic sensors 11 and the polarity reversal cycle (e.g., 45°) in accordance with the rotation of the magnet rotor 5 are appropriately reflected on each of sensor signals S1, S2, S3 that a respective one of the magnetic sensor 11 outputs.

According to the construction of the embodiment, the following advantage and effects are attained. First, the brushless motor 1 includes the magnet rotor 5 including the ring magnet 10 secured to the outer circumferential surface of the rotor core 8 and rotatably supported. The brushless motor 1 further includes the stator 4 which includes the plural teeth 3 positioned facing, or being opposed to the ring magnet 10 and is positioned radially outward of the magnet rotor 5. The brushless motor 1 includes the magnetic sensors 11 (11a, 11b, 11c) for detecting the rotation position of the magnet rotor 5 on the basis of the leakage magnetic flux of the magnet rotor 5 leaking in the axial direction. The short-sized portion 20 having radial dimension (length) L1 is formed at the axial end portion 10a of the ring magnet 10 facing each of the magnetic sensors 11.

That is, according to the construction of the embodiment, by forming the region with high reluctance (high reluctance region) by increasing the air gap between the ring magnet 10 and each of the teeth 3 (the air gap relative to each of the teeth 3) by the short-sized portion 20, the leakage magnetic flux leaking in the axial direction of the magnet rotor 5 can be increased. Further, by providing the short-sized portion 20 at the axial end portion 10a of the ring magnet 10 facing each of the magnetic sensors 11, the leakage magnetic flux that passes each of the magnetic sensors 11 can be increased effectively. That is, the region with high reluctance (high reluctance region) that the short-sized portion 20 forms can be minimized, or reduced. Thus, while restraining the reduction of the effective flux quantum that contributes to the rotation of the magnet rotor 5, the rotation position of the magnet rotor 5 can be detected with high precision.

Second, the ring magnet 10 includes the axial dimension (height) H1 longer than the axial dimension (height) H0 of each of the teeth 3. The short-sized portion 20 is arranged at the position closer to each of the magnetic sensors 11 than the axial end portion 3a of each of the teeth 3 relative to a respective one of the magnetic sensors 11 in the axial direction. That is, a distance between the short-sized portion 20 and each one of the magnetic sensors 11 in the axial direction is shorter than a distance between the axial end portion 3a of each of the teeth 3 and each one of the magnetic sensors 11 in the axial direction.

According to the foregoing construction, the leakage magnetic flux that passes each of the magnetic sensors 11 can be increased more effectively without reducing an opposing region, or facing region of the ring magnet 10 relative to each of the teeth 3. Further, the influence of the leakage magnetic flux to the stator 4 can be reduced. Thus, the rotation position of the magnet rotor 5 can be detected with further high precision.

Third, the short-sized portion 20 is formed by removing, or cutting out a portion of the axial end portion 10a of the ring magnet 10 at radially outward side (outside) to have a groove, or to be in a groove shape. Accordingly, the short-sized portion 20 can be formed readily.

Fourth, each of the magnetic sensors 11 is provided at a position where the Hall element 12 serving as the magnetic detection element provided within the magnetic sensor 11 faces, or is opposed to the ring magnet 10 in the axial direction. According to the construction described above, the influence of the leakage flux to the stator 4 can be reduced. In consequence, the rotation position of the magnet rotor 5 can be detected with higher precision.

The construction of the embodiment can be modified as follows. According to the embodiment, the magnet rotor 5 includes the ring magnet 10 which is secured to the outer circumferential surface of the rotor core 8. However, the construction is not limited. Alternatively, plural plate shaped magnets or plural roofing-tile-shaped magnets may be secured to the outer circumferential surface of the rotor core 8.

According to the embodiment, the brushless motor including the surface magnet type magnet rotor 5 (SPM motor) is applied. Alternatively, a brushless motor including an embedded magnet type magnet rotor (an interior permanent magnet motor, IPM motor) may be applied.

According to the embodiment, the inner rotor type brushless motor 1 in which the magnet rotor 5 rotates at radially inward of the stator 4 is applied. Alternatively, an outer rotor type brushless motor in which a magnet rotor rotates at radially outward of a stator may be applied.

The number of magnetic poles of the magnet rotor 5 and the number of the teeth 3 (the number of slots) of the stator 4 may be changed.

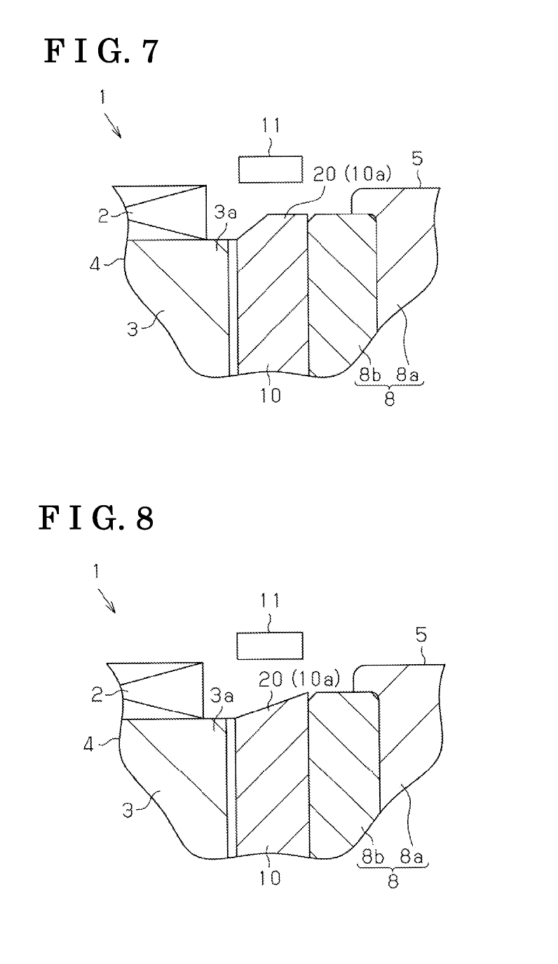

According to the embodiment, the short-sized portion 20 is formed by removing, or cutting out a portion of the axial end portion 10a of the ring magnet 10 at radially outward thereof to have a groove, or to be in a groove shape. However, the construction is not limited. Alternatively, the short-sized portion 20 may be formed to have an inclined surface, or slope so that a radial dimension (length) is reduced as being closer to an axial end of the ring magnet 10 (i.e., upper in FIGS. 7 and 8).

For example, as illustrated in FIGS. 7 and 8, the short-sized portion 20 may be formed by chamfering a corner portion of a radially outward portion of the axial end portion 10a. Many of permanent magnets have a property that a corner portion of an axial end portion thereof is subject to be broken, or chipped. According to the construction that adopts the ring magnet 10 including the short-sized portion 20, it is critical to maintain the configuration of the axial end portion 10a. According to the construction, for example as illustrated in FIGS. 7 and 8, the corner portion of the axial end portion 10a is restrained from being broken, or chipped. Thus, by stably maintaining the configuration of the short-sized portion 20, the rotation position of the magnet rotor 5 can be detected with high precision.

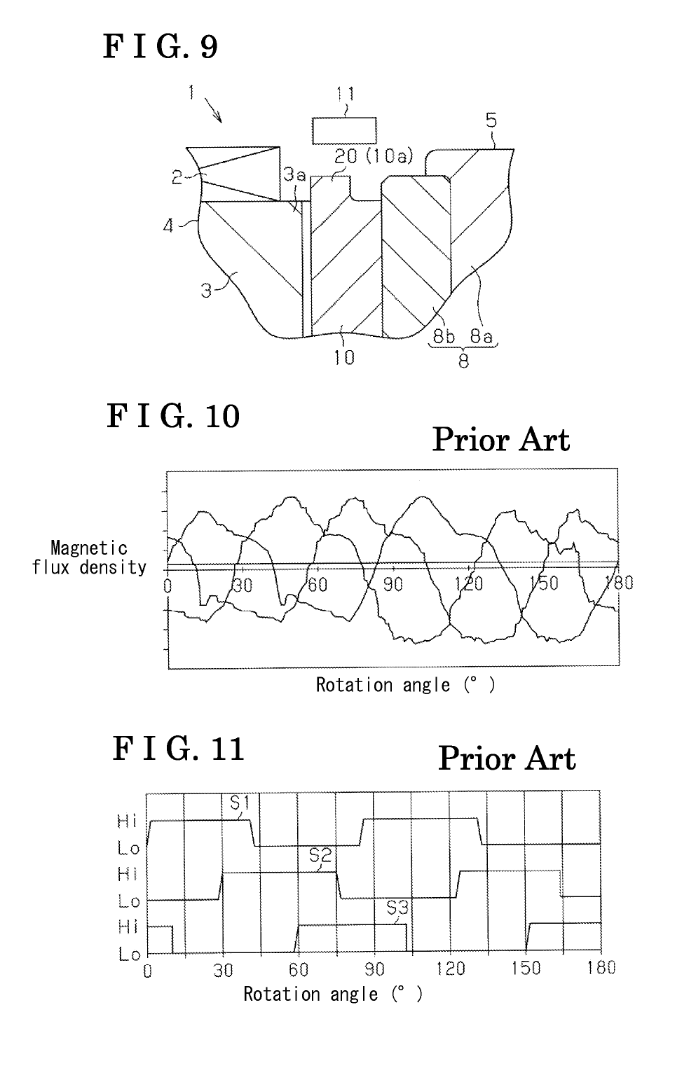

Further, as illustrated in FIG. 9, alternatively, the short-sized portion 20 may be formed by removing, or cutting out a portion of a radially inward portion of the axial end portion 10a of the ring magnet 10 (i.e., right-hand side in FIG. 9). That is, in this case, by forming the short-sized portion 20, an air gap is formed between the short-sized portion 20 of the ring magnet 10 and a magnetic path forming portion (i.e., outer ward portion 8b of the rotor core 8) at the magnet rotor 5 (air gap is formed relative to a magnetic path forming portion (i.e., outer ward portion 8b of the rotor core 8) at the magnet rotor 5). Thus, because a high reluctance region is formed, the leakage magnetic flux leaking in the axial direction of the magnet rotor 5 is increased. Accordingly similar effects and advantages to the embodiment can be attained.

Further, the short-sized portion 20 may be formed by other structures, for example, by removing, or cutting out a portion of the axial end portion 10a of the ring magnet 10 at a radially inward side and radially outward side thereof.

According to the construction of the embodiment, the ring magnet 10 includes the axial dimension H1 which is longer than the axial dimension H0 of each of the teeth 3, and the short-sized portion 20 is arranged at the position closer to each of the magnetic sensors 11 than the axial end portion 3a of each of the teeth 3 relative to the magnetic sensor 11. However, the construction of the disclosure is not limited to the foregoing. Alternatively, for example, the axial dimension H1 of the ring magnet 10 may be equal to or shorter than the axial dimension H0 of each of the teeth 3. Further, alternatively, the short-sized portion 20 may include a portion arranged at the position which is farther, or more distant from each of the magnetic sensors 11 than the axial end portion 3a of each of the teeth 3 in the axial direction.

According to the embodiment, the Hall IC including the Hall element 12 is applied as the magnetic sensor 11. Alternatively, the magnetic sensor 11 may include a reluctance element serving as a magnetic detection element.

According to the embodiment, the brushless motor (1) includes the magnet rotor (5) including the rotational shaft (7) and the permanent magnet (10), the magnet rotor (5) rotatable about the rotational shaft (7), the stator (4) including the plural teeth (3) provided at a radial position being opposed to a circumferential surface of the magnet rotor (5), and the magnetic sensor (11) for detecting a rotation position of the magnet rotor (5) on the basis of a leakage magnetic flux of the magnet rotor (5) leaking in an axial direction of the rotational shaft (7). The permanent magnet (10) includes the short-sized portion (20) provided at the axial end portion (10a) thereof facing the magnetic sensor (11). The short-sized portion (20) has a shorter length than an entire radial dimension of the permanent magnet (10).

That is, by an air gap formed by the short-sized portion (20), a region with high reluctance is formed on the magnetic path. Thus, the leakage magnetic flux leaking in the axial direction of the magnet rotor (5) increases. Further, by providing the short-sized portion (20) at the axial end portion (10a) of the permanent magnet (ring magnet 10) facing the magnetic sensor (11), the leakage magnetic flux that passes the magnetic sensor (11) can be increased effectively. Namely, the region with high reluctance (high reluctance region) formed by the short-sized portion (20) can be minimized, or reduced. Accordingly, with the construction described above, a rotation position of the magnet rotor (5) is detectable with high precision while restraining the reduction of effective flux quantum that contributes to the rotation of the magnet rotor (5). By the adoption of the construction that the configuration of the permanent magnet (ring magnet 10) is changed, distinguished effects and advantages can be attained even for the brushless motor (SPM motor) (1) which includes the surface magnet type magnet rotor.

According to the construction of the embodiment, the permanent magnet (10) includes the axial dimension (H1) longer than the axial dimension (H0) of each of the teeth (3). The short-sized portion (20) is arranged at a position closer to the magnetic sensor (11) than an axial end portion of each of the teeth (3) in the axial direction of the rotational shaft (7).

According to the construction of the embodiment, the leakage magnetic flux that passes the magnetic sensor (11) can be increased more effectively without reducing the region that is opposed to each of the teeth (3) at the permanent magnet (ring magnet 10). Further, the influence of the leakage magnetic flux to the stator (4) can be reduced. In consequence, the rotation position of the magnet rotor (5) is detectable with higher precision.

According to the embodiment, the short-sized portion (20) is formed by cutting out at least one of a portion of a radially inner side and a portion of a radially outer side of the axial end portion of the permanent magnet (10).

According to the construction of the embodiment, the short-sized portion (20) can be formed readily.

According to the embodiment, the short-sized portion (20) includes an incline to make the entire radial dimension of the permanent magnet (10) be shorter as being closer to an axial tip end side of the rotational shaft (7).

According to the embodiment, the magnetic sensor (11) includes a magnetic detection element (12) and is provided at a position where the magnetic detection element (12) is opposed to the permanent magnet (10) in the axial direction of the rotational shaft (7).

According to the construction of the embodiment, the influence of the leakage magnetic flux to the stator (4) can be reduced. In consequence, the rotation position of the magnet rotor (5) can be detected with higher precision.

According to the embodiment, the brushless motor further includes the rotor core (8). The magnet rotor (5) is formed by securing the permanent magnet (10) to a circumferential surface of the rotor core (8).

According to the embodiment, the magnet rotor (5) is positioned radially inward relative to the stator (4).

According to the embodiment, the brushless motor (1) includes the magnet rotor (5) including the rotational shaft (7) and the permanent magnet (10), the magnet rotor (5) rotatable about the rotational shaft (7), the stator (4) including the plural teeth (3) positioned at a radial position being opposed to a circumferential surface of the magnet rotor (5), and the magnetic sensor (11) positioned being opposed to the permanent magnet (10). The magnetic sensor (11) is for detecting a rotation position of the magnet rotor (5) on the basis of a leakage magnetic flux of the magnet rotor (5) leaking in an axial direction of the rotational shaft (7). The permanent magnet (10) includes the short-sized portion (20) provided at the axial end portion (10a) thereof being opposed to the magnetic sensor (11). The short-sized portion (20) has a shorter length than an entire radial dimension of the permanent magnet (20).

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A brushless motor, comprising:
a magnet rotor including a rotational shaft and a permanent magnet, the magnet rotor rotatable about the rotational shaft;
a stator including a plurality of teeth provided at a radial position being opposed to a circumferential surface of the magnet rotor; and
a magnetic sensor for detecting a rotation position of the magnet rotor on the basis of a leakage magnetic flux of the magnet rotor leaking in an axial direction of the rotational shaft; wherein
the permanent magnet includes a short-sized portion provided at an axial end portion thereof facing the magnetic sensor, the short-sized portion having a shorter length than an entire radial dimension of the permanent magnet.

2. The brushless motor according to claim 1, wherein the permanent magnet includes an axial dimension longer than an axial dimension of each of the teeth; and
the short-sized portion is arranged at a position closer to the magnetic sensor than an axial end portion of each of the teeth in the axial direction of the rotational shaft.

3. The brushless motor according to claim 1, wherein the short-sized portion is formed by cutting out at least one of a portion of a radially inner side and a portion of a radially outer side of the axial end portion of the permanent magnet.

4. The brushless motor according to claim 1, wherein the short-sized portion includes an incline to make the entire radial dimension of the permanent magnet be shorter as being closer to an axial tip end side of the rotational shaft.

5. The brushless motor according to claim 1, wherein the magnetic sensor includes a magnetic detection element and is provided at a position where the magnetic detection element is opposed to the permanent magnet in the axial direction of the rotational shaft.

6. The brushless motor according to claim 1, further comprising:
a rotor core; wherein
the magnet rotor is formed by securing the permanent magnet to a circumferential surface of the rotor core.

7. The brushless motor according to claim 1, wherein the magnet rotor is positioned radially inward relative to the stator.

8. The brushless motor according to claim 3, wherein the magnetic sensor includes a magnetic detection element and is provided at a position where the magnetic detection element is opposed to the permanent magnet in the axial direction of the rotational shaft.

9. A brushless motor, comprising:
a magnet rotor including a rotational shaft and a permanent magnet, the magnet rotor rotatable about the rotational shaft;
a stator including a plurality of teeth positioned at a radial position being opposed to a circumferential surface of the magnet rotor; and
a magnetic sensor positioned being opposed to the permanent magnet, the magnetic sensor for detecting a rotation position of the magnet rotor on the basis of a leakage magnetic flux of the magnet rotor leaking in an axial direction of the rotational shaft; wherein
the permanent magnet includes a short-sized portion provided at an axial end portion thereof being opposed to the magnetic sensor, the short-sized portion having a shorter length than an entire radial dimension of the permanent magnet.
